(19) United States
(12) Patent Application Publication
(10) Pub. No.: US 2006/0044328 A1
(43) Pub. Date: Mar. 2, 2006

(54) Overlay control circuit and method

(76) Inventors: Barinder Singh Rai, Surrey (CA); Atousa Soroushi, North Vancouver (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/926,657

(22) Filed: Aug. 26, 2004

(51) Int. Cl. G09G 5/00

(52) U.S. Cl. 345/629

(57) ABSTRACT

An overlay control circuit and method. In a preferred embodiment of the invention, a graphics controller provides main image data and overlay image data to a display device and includes a memory for storing the main image data and the overlay image data and a logic circuit for producing a signal that, in an active state, indicates that a particular location in the display device is to be represented by the overlay image data. The overlay control circuit fetches the main image data from the memory and is further adapted to respond to a transition in the indicating signal to the active state by halting the fetching.

### FIELD OF INVENTION

The invention relates to digital image processing. More particularly, the invention is directed to an overlay circuit and method for reducing memory bandwidth and power consumption requirements when displaying a main image overlaid by an overlay image.

### BACKGROUND

Digital images are comprised of arrays of pixels. A pixel is a discrete element in a display screen that can be illuminated with a particular color and degree of brightness. The term pixel is also used to refer to the datum that define the color and intensity of the physical pixels in display and hard copy rendering devices.

Graphics display systems typically employ a graphics controller for controlling the flow of image data from a host processor or a peripheral device, such as a camera, to a display device such as an LCD. Commonly, graphics display systems are employed in all types of computer systems, including portable devices, such as cellular telephones, personal digital assistants, music players, and other battery powered devices.

Image data are typically stored in a memory, which may be embedded in the graphics controller. The graphics controller refreshes the display device with image data at around 60 times per second, depending on the particular device, by fetching image data from the memory and writing it to the display device. The graphics controller refreshes the pixels in the display device in raster sequence. A raster sequence proceeds from left to right and top to bottom.

The memory in graphics display systems is commonly accessed by other devices and a predetermined amount of time is required to read or write a byte of data. The term memory bandwidth is used in this specification to refer to the memory's capacity for data transfer. Memory bandwidth is fixed. And when access to memory is required by many devices or large data transfers are required, the memory bandwidth may be insufficient to accommodate all demands in a timely manner. Accordingly, reducing demand for memory bandwidth is generally always desirable.

More than one image may be rendered on the display device simultaneously. Often when two or more images are displayed, one image overlays another. Each of the images may be stored separately in memory. For example, main image data defining a main image may be stored in a first portion of the memory and overlay image data defining an overlay image may be stored in a second portion. Typically, the main image is displayed so that it appears to lay under the overlay image. Because the overlay image is positioned over the main image at particular display locations, it can be defined by an overlay window, which generally is rectangular. The main image data corresponding to the overlay window are masked by the overlay image and cannot be seen.

All of the main image data are fetched from the memory in each refresh cycle. However, not all of the main image data are transmitted to the display. Main image data are transmitted for all pixel locations in the display except for the pixel locations where the overlay window is displayed. For overlay window pixel locations, overlay image data are transmitted to the display.

It is a problem of no small significance that main image data are fetched from memory for pixel locations in the display for which overlay image data is displayed. It is a problem because image data are fetched, but not used. Memory bandwidth and power are required to fetch data from memory. A graphics display system which fetches data, but does not use it wastes memory bandwidth and power. Such systems may be acceptable if the simultaneous display of a main and overlay image is infrequent. But where main and overlay images are frequently rendered together on a display, the amount of memory bandwidth wasted can be significant. Further, a significant amount of power can be wasted. And in battery powered devices, power conservation is critical.

Accordingly, there is a need for an overlay control circuit and method that reduces memory bandwidth requirements and conserves power.

### SUMMARY

The invention is directed to an overlay control circuit and method. Preferably, the overlay control circuit and method is employed in a graphics controller, and the principles of the invention are illustrated in this context in this specification. However, control circuits and methods according to the invention may be used in other contexts as desired.

With respect to a preferred overlay control circuit, a graphics controller provides main image data and overlay image data to a display device. The graphics controller preferably includes a memory for storing the main image data and the overlay image data, an overlay indicator circuit for producing an indicating signal, and an overlay control circuit.

The overlay control circuit causes main image data to be fetched from memory. The indicating signal, when asserted, indicates that a datum of the overlay image data is to be represented at a particular pixel location in the display device. The overlay control circuit stops fetching main image data when the indicating signal is asserted.

Preferably, the memory comprises a first portion for storing the main image data and a second portion for storing the overlay image data. A main image display pipe is provided for transmitting the main image data from the first portion of the memory to the display device. In addition, an overlay image display pipe is provided for transmitting the overlay image data from the second portion of the memory to the display device. The overlay control circuit writes the main image data fetched from the first portion of the memory to the main image display pipe and writes the overlay image data fetched from the second portion of the memory to the overlay image display pipe.

In one preferred embodiment, the invention is directed to a computer system incorporating the principles of the invention.

In another embodiment, the invention is directed an overlay control method according to the principles of the invention.

In yet another embodiment, the invention is directed to machine readable media embodying a program of instructions according to the principles of the invention.

This summary is provided as a means of generally determining what follows in the drawings and detailed description and is not intended to limit the scope of the invention. Objects, features and advantages of the invention will be more readily understood upon consideration of the following detailed description taken in conjunction with the accompanying drawings.

### DESCRIPTION OF THE DRAWINGS

FIG. 1 is a pictorial view of a display screen showing a main and an overlay image illustrating the context of the invention.

FIG. 2 is a schematic of the overlay image of FIG. 1 in relationship to rows and columns on the display.

FIG. 3 is block diagram of a graphics display system, which includes a graphics controller having an overlay control circuit according to the invention.

FIG. 4 is block diagram of the overlay control circuit of FIG. 3.

FIG. 5 is a schematic of an overlay-indicating circuit for indicating the status of overlay image data as a function of the rows and columns of FIG. 2.

FIG. 6 is a timing diagram illustrating a scaling aspect of the invention.

### DETAILED DESCRIPTION OF A PREFERRED EMBODIMENT

The invention is directed to an overlay circuit and method for reducing memory bandwidth and power consumption requirements when displaying a main image overlaid by an overlay image. This specification describes the present preferred embodiments of the invention, examples of which are illustrated in the accompanying drawings. Whenever possible, the same reference numbers are used in the drawings and specification to refer to the same or like parts, blocks, and steps.

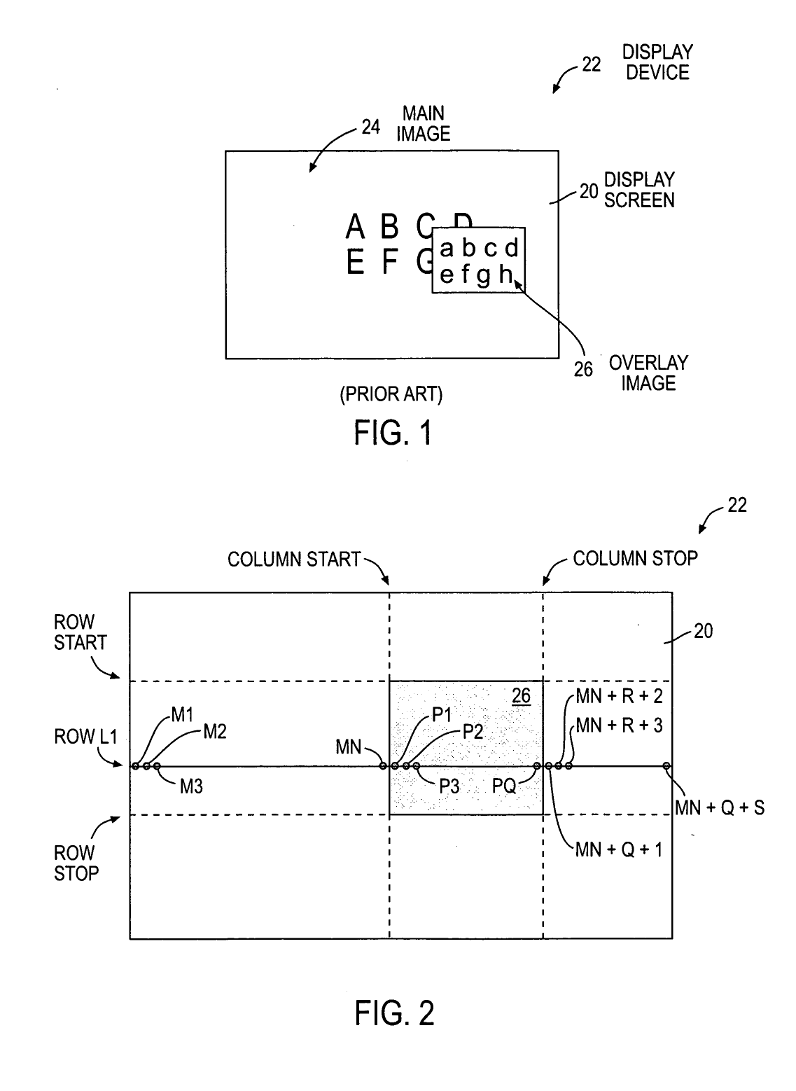

FIG. 1 shows a display screen 20 of a display device 22. The display device 22 is typically an LCD panel but may be any device capable of rendering image data, including CRT and OLED display devices, as well as hard copy rendering devices, such as printers. The screen 20 displays a main image 24. Often the main image 24 is coextensive with the area of the screen 20 for displaying main image data, though this is not necessary. The screen 20 may also include an overlay image 26 that is typically rectangular for displaying overlay image data, though this too is not essential. The size and location of the overlay display area 26 within the screen 20 are variable. As mentioned, when overlay image data are displayed in the display area 26, main image data corresponding to the same display space are masked or hidden by the overlay image data.

FIG. 2 shows the position of the overlay display area 26 on the screen 20. Pixel locations on the screen 20 are defined by intersections of horizontal rows and vertical columns and the rectangular overlay image 26 is defined as the area between two rows and two columns. Specifically, the area bounded by “row start,” “row stop,” “column start,” and “column stop” defines the position and dimensions of the overlay image 26.

FIG. 2 illustrates how main and overlay image data are mapped to a row L1 of display device 22, as well as the order in which image data are typically written to the display. In FIG. 2, an “M” denotes a main image pixel and a “P” denotes an overlay image pixel.

Beginning at the left end of the row, the pixels M1, M2, M3, . . . MN are mapped into sequential pixel locations of the row L1. These pixels correspond to N pixels of main image data. Specifically, the pixels are mapped into pixel locations in the row L1 of the display device beginning with the first (left-most) column and continue up to the shown column start column. No overlay pixels are mapped into these pixel locations.

Continuing sequentially in the row L1 and beginning at the column start pixel location, the pixels P1, P2, P3, . . . PQ are mapped into sequential pixel locations of the row L1. These pixels correspond to Q pixels of overlay image data and are mapped into the pixel locations up to the shown column stop pixel location.

In addition, the pixels MN+1, MN+2, MN+3, . . . MN+Q are also mapped into the same pixel locations in the row L1 as the pixels P1, P2, P3, . . . PQ, corresponding to Q pixels of main image data. These main image pixels, however, cannot be seen in the display device 22 because they lie underneath the overlay image 26.

Beginning in the pixel location after the column stop pixel location, the pixels MN+Q+1, MN+Q+2, MN+Q+3, . . . MN+Q+S are mapped into sequential pixel locations of the row L1. These pixels correspond to S pixels of main image data and are mapped into pixel locations up to the right end of the row L1. No overlay pixels are mapped into these pixel locations.

The preceding paragraphs describe how pixels are mapped to pixel locations in a row of the display device 22. As mentioned, the image data are typically written on the display device 22 in raster order. Thus, the pixels are typically written to the display device in the order in which they are sequentially mapped. In other words, the pixels for the row L1 are typically written to the display device 22 in the following order: M1, M2, M3, . . . MN, P1, P2, P3, . . . PQ, MN+Q+1, MN+Q+2, MN+Q+3, . . . MN+Q+S. Further, the overlay image pixels: MN+1, MN+2, MN+3, . . . MN+Q are not written to the display device 22

As will be readily appreciated, image data may be written to the display in some order other than raster order. In embodiments other than those described in this specification, the principles of the invention may be adapted to accommodate image data written to a display device in other than raster order.

Image data are mapped in a similar fashion with respect to the vertical dimension. Main image data are mapped to all of the pixel locations of a column, and overlay image data are mapped to the column between a row start and row stop. In the vertical dimension, when both main image data and overlay image are mapped to the same location, the main image data are not displayed.

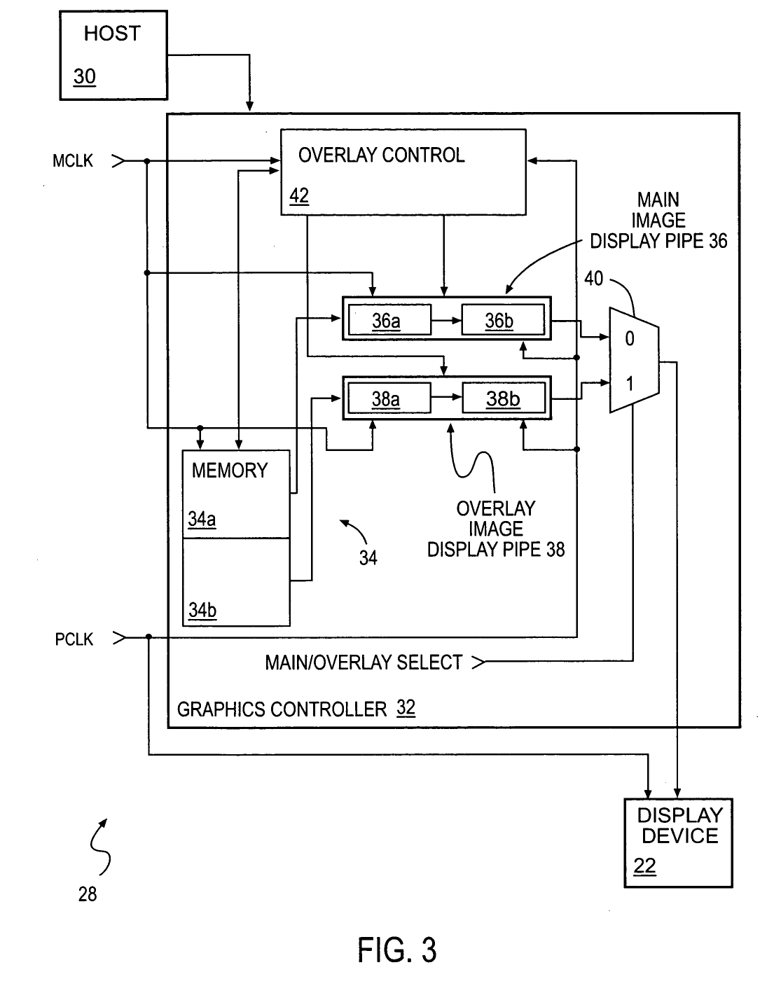

FIG. 3 is block diagram of a graphics display system 28 including a host processor or computer 30, the display device 22, and a graphics controller 32 according to the principles of the invention. The graphics controller 32 preferably includes a memory 34, though the memory 34 may be provided separately, such as in a separate integrated circuit. Image data are stored in the memory 34 by the host 30 or by an image capture device, such as a camera or an image scanner. The image data for a main and overlay image may be stored in the respective portions of the memory 34 in raster or in any other order. Image data are then transferred from the memory 34 to the display device 22. The display device 22 may or may not have an associated memory for intermediately storing or manipulating image data transmitted to it.

The memory 34 is commonly accessed by devices other than circuitry for fetching pixels for the display 22. To prevent the display device 22 from being starved of image data while another device is accessing the memory 34, portions of the image data are read from the memory and written to a buffer, which in turn provides the data to the display device.

The buffer is typically a FIFO, though this is not essential. In this specification, the buffer is referred to as a “display pipe.” Preferably, the graphics controller 32 includes two display pipes. A main image display pipe 36 transmits each of the main image datum from the memory 34 to the display 22. An overlay image display pipe 38 transmits each of the overlay image datum from the memory 34 to the display 22. The main and overlay image pipes are operated in parallel.

The memory 34 preferably includes a first portion 34a for storing main image data and a second portion 34b for storing overlay image data. Main image data are fetched from the first portion 34a and written to the main image display pipe 36. Overlay image data are fetched from the second portion 34b and written to the overlay image display pipe 38.

Each of the display pipes is divided into two stages. A first stage 36a of the display pipe 36 is in connected in series with a second stage 36b, and a first stage 38a of the display pipe 38 is connected in series with a second stage 38b. Additional display pipes may be provided for additional overlay images.

The first stages 36a, 38a are clocked at a rate (“MCLK”) appropriate for reading from the memory. The second stages 36b, 38b are clocked at a rate (“PCLK”) appropriate for writing data to the display. Typically, the memory clock rate MCLK is a higher frequency than the display clock PCLK. Image data are fetched from the memory 34 and written to fill the first stages of the display pipes when these stages reach a predetermined level of fullness. Image data is written to a display pipe 36, 38 until the first stage is filled. The dual frequency data transfer capability of the display pipes 36, 38 allows the pipes to be rapidly filled with image data and emptied at a relatively slow rate. While the display pipes 36, 38 are being emptied, other devices may access the memory. But when a display pipe starts getting near empty, it is rapidly refilled at the MCLK rate. By using the display pipes 36, 38 to transfer data to the display device 22, the display device is never starved of image data.

The outputs of the second stages 36b, 38b of the display pipes are coupled to a multiplexer 40. The output of the multiplexer 40 is coupled to the display device 22. A main/overlay select signal is used to select one of the inputs of the multiplexer 40. The signal selects a pixel for each particular pixel location in the display screen 20. The signal selects either a main image pixel from the main image display pipe 36 or an overlay image pixel from the overlay image display pipe 38. The main/overlay select signal is generated by a main/overlay active circuit (not shown).

When the main/overlay select signal causes an overlay image pixel to be displayed at particular pixel location, the corresponding main image pixel is not displayed. The main image data for this pixel is not used, even though the data was fetched from the memory 30 and transmitted through the main image display pipe 36. Not displaying the main image pixel is a significant problem.

The graphics controller 32 includes an overlay control circuit 40 according to the invention, which provides a solution to this problem. The overlay control circuit 42 includes a memory access controller 44 adapted to fetch data from the memory 34 and cause the image data fetched from the memory to be written to the respective pipes 36, 38.

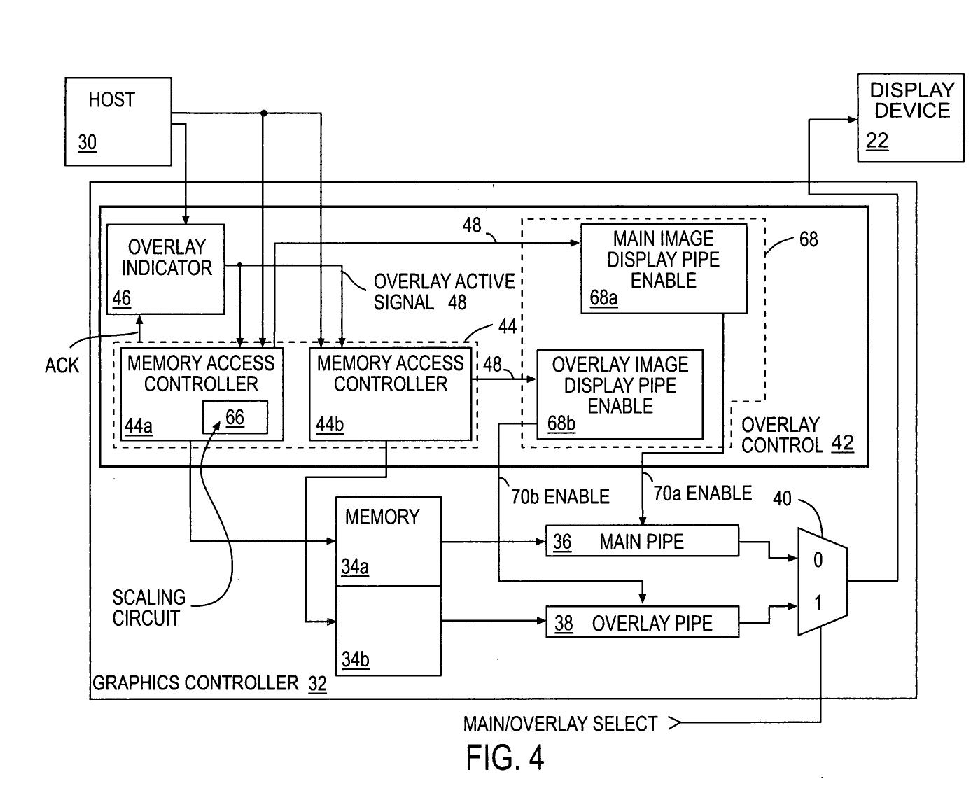

Referring to FIG. 4, a preferred embodiment of the overlay control circuit 42 is shown together with elements of the graphics display system 28. The memory access controller 44 may comprise a separate controller 44a and 44b for main and overlay image data as shown, though this is not essential.

In operation, the memory access controller 44a causes main image data to be fetched from the memory portion 34a and written to the first stage of the main image display pipe 36a. The memory access controller 44b causes overlay image data to be fetched from the memory portion 34b and written to the first stage of the overlay image display pipe 38a.

The memory access controller 44a is coupled to an overlay indicator circuit 46 that generates an overlay active signal 48. The overlay active signal 48 provides an indication as to where in the display screen 20 the overlay image data are to be mapped. Particularly, for each pixel location on the display device, the overlay indicator circuit 46 sends an overlay-active signal 48. If the signal is asserted with respect to a particular location, it is “active” and it indicates mapping an overlay pixel. If the signal is not asserted with respect to a particular location, it is not active and it indicates mapping a main image pixel.

In one embodiment, the overlay-active signal 48 is used to control fetches from the memory 34. More particularly, for a pixel destined for a particular location in the display device 22 for which the overlay-active signal 48 is active, the memory access controller portion 44a is adapted to prevent further access to the portion 34a of the memory 34 containing main image data. The flow of main image data into the main image display pipe 36 is stopped so that main image data that are to be overwritten by overlay image data are not fetched from the memory. This provides the outstanding advantages of increasing memory bandwidth and decreasing power consumption. Accesses to the memory portion 34a are resumed when the overlay-active signal 48 is no longer active. Further, while the overlay-active signal 48 is active, the memory access controller portion 44b is adapted to cause overlay pixels to be fetched from the portion 34a of the memory 34 and written to the overlay display pipe 38; and when the overlay-active signal 48 is no longer active, the memory access controller 44b is adapted to stop the flow of overlay image data into the overlay image display pipe 38.

For example, referring back to FIG. 2, to populate the row L1, the signal 48 is initially inactive, and pixels M1, M2, M3, . . . MN are fetched sequentially from the memory portion 34a. These main image pixels are written to the main image display pipe 36, transmitted through the pipe, and selected at the multiplexer 40 for provision to the display device 22. In correspondence with the next pixel following MN, however, the overlay-active signal 48 becomes active. Fetches from the memory portion 34a cease. Instead, overlay image pixels P1, P2, P3, . . . PQ are fetched from the memory 34b, transferred through the overlay image display pipe, and selected at the multiplexer 40 for provision to the display device 22. Finally, for the next pixel following PQ, the signal 48 again becomes inactive. The memory access controller 44a increments the read address for reading the next main image pixel from that required to fetch the last value MN to that required to fetch the new value MN+Q+1, skipping the Q pixels MN+1, MN+2, MN+3, . . . MN+Q in memory 34a that correspond to the same display locations as the overlay image data.

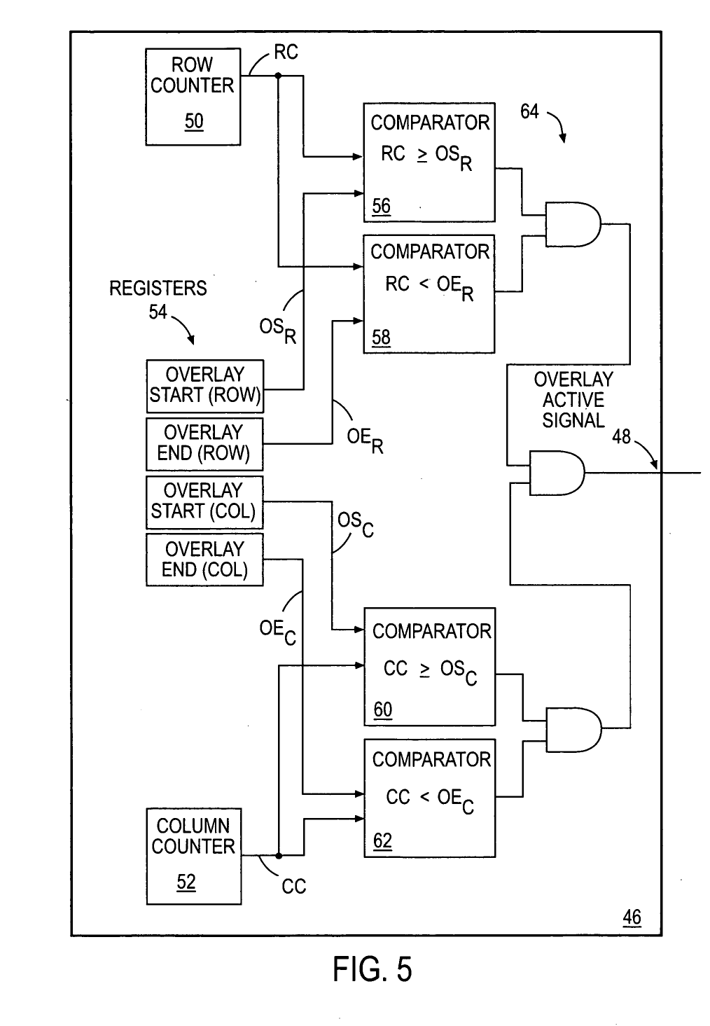

FIG. 5 shows an exemplary overlay indicator circuit 46. The overlay indicator circuit 46 includes row and column counting circuits 50 and 52. The row and column counting circuits 50, 52 count rows and columns in the display screen 20, respectively, of pixels fetched from memory. The overlay indicator circuit 46 includes registers 54 for storing overlay-start (row) OS_{R} and overlay-end (row) OE_{R} parameters, which indicate the starting and stopping rows of the overlay image 26 in the display screen 20. The registers 46 are also employed to store overlay-start (col) OS_{C} and overlay-end (col) OE_{C}, which indicate the starting and stopping columns of the overlay image 26 in the display screen 20. The overlay indicator circuit 46 also includes comparators 56, 58, 60, and 62. The comparators 56, 58 compare the row count to the row start and row stop parameters stored in the registers 54. Similarly, the comparators 60, 62 compare the column count to the column start and stop parameters stored in the registers 54. The outputs of the comparators 56, 58 are coupled to one of the AND gates 64, and the outputs of the comparators 60, 62 are coupled to another of the AND gates 64, as shown in the figure. The outputs of these AND gates are coupled to a third AND gate 64, as shown. The output of the third AND gate is the overlay active signal 48.

As can be seen from FIG. 5, the overlay active circuit 46 is adapted to identify the pixel locations in the display screen 20 where the overlay image is to be displayed as pixels are fetched from memory. When these overlay pixel locations are identified, the circuit 46 asserts the overlay active signal 48 and main image pixels are not fetched from memory.

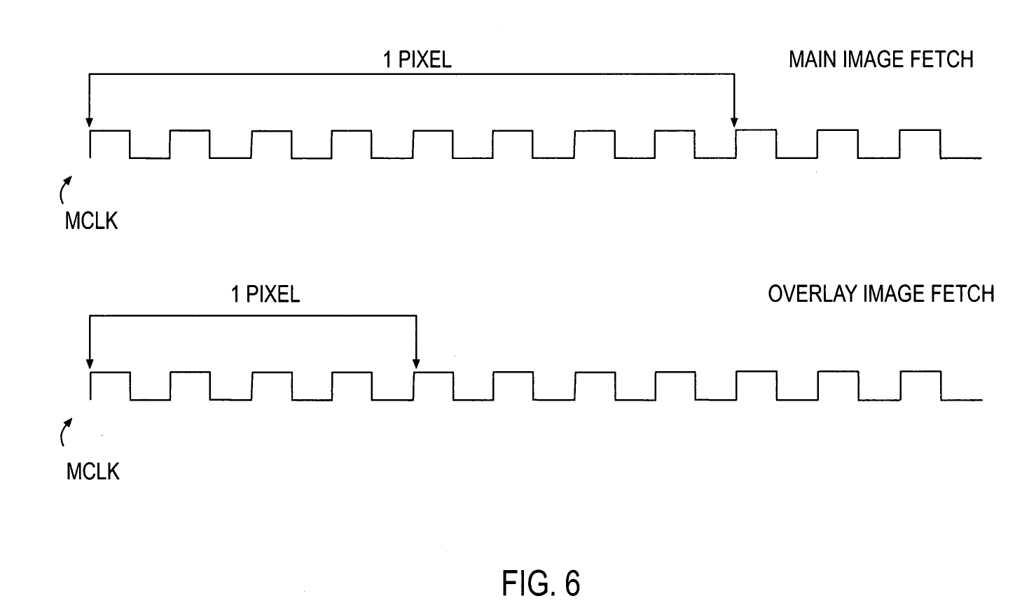

In general, the resolution of the overlay image data and the main image data may differ. As the term is used in this specification, resolution refers to the depth of the image data (“pixel depth”). For example, in a bi-level image, each pixel is represented by a single bit of data. In a gray-scale image, each pixel is typically represented by a 30 bit data word. In a color image, each pixel may be represented by an 8, 16, 24, or 36 bit data word. Where an 8-bit data word may represent one of 256 different colors, a 16-bit data word may represent one of 65,536 different colors, and so on. The pixel depth is the number of bits needed to define a pixel. Pixel depth is related to resolution in that pixel depth describes how accurately the image will be rendered.

Where the resolution of overlay image data and main image data differ, as indicated in FIG. 6, more (or fewer) clock cycles may be required to fetch one main image pixel than one overlay image pixel. The example shown in FIG. 6 assumes that pixels in the main image have twice the resolution of the pixels in the overlay image. Accordingly, it takes twice as many MCLK cycles to fetch a main image pixel as it takes to fetch an overlay pixel. Hence, the amount by which the memory access controller 38a needs to increment the address for fetching main image data (e.g., from that required for fetching the last pixel MN of the row L1 in FIG. 2 to the next pixel MN+Q+1) is greater by a factor of two than it would be if the main and overlay image pixels had the same resolution.

To accommodate differences in resolution between the two types of image data,a scaling circuit 66 is therefore preferably provided for the memory access controller 44a. The scaling circuit 66 assists the memory access controller 44a in determining the amount the address must be incremented where the resolution of the pixels is different. The host 30 may inform the scaling circuit of the anticipated difference in resolution, or this information may be provided to the scaling circuit from some other source. The scaling circuit 66 may reside in the memory access controller 44a or may reside outside the controller 44, functioning as a co-processor.

In a preferred embodiment of the invention, the overlay-active signal 48 is used by the memory access controller 44 to turn the main and overlay image display pipes 36, 38 off to further reduce power consumption. The overlay control circuit 42 preferably includes a pipe enable controller 68 to enable or disable the first stages of the pipes from receiving more data.

The pipe enable controller 68 may comprise a separate main image display pipe enable controller 68a and an overlay image display pipe controller 68b as shown in FIG. 4, though this is not essential. The memory access controller 44a is coupled to the main image display pipe enable controller 68a, and the memory access controller 44b is coupled to an overlay image display pipe controller 68b. The respective memory access controllers 44a, 44b provide the display pipe enable controllers 68a, 68b with a copy of the overlay active signal 48. For a pixel on the display screen 20 for which the overlay-active signal 48 is active, the memory access controller 38a sends the signal to the pipe enable controller 68a, which responds by de-asserting an enable signal 70a that turns off one or both stages 36a and 36b of the main image display pipe 36. The pipe 36 is turned back on when the overlay-active signal 48 is no longer active. In a similar fashion, for a pixel on the display screen 20 for which the overlay-active signal 48 is not active, the memory access controller 38b sends the signal to the pipe enable controller 68b, which responds by de-asserting an enable signal 70b that turns off one or both stages 38a and 38b of the overlay image display pipe 38. It will be appreciated that the above references to “turning off” a pipe includes causing the pipe to enter an energy saving “sleep” state.

As will be readily appreciated by persons of ordinary skill, the overlay-active signal 48 should be synchronized with the flow of data through the two display pipes to achieve the desired output on the screen of the display device.

Overlay control circuits and methods according to the present invention may be implemented in hardware or software, or both, and may employ machine readable media embodying one or more programs of instruction executed by the machine as will be readily apparent to persons of ordinary skill in the art.

It should be recognized that, while a specific overlay control circuit and method has been shown and described as preferred, other configurations and methods could be utilized, in addition to those already mentioned, without departing from the principles of the invention.

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims that follow.

1. A graphics controller for providing main image data and overlay image data to a display device, comprising:
a memory for storing the main image data and the overlay image data;
an indicating circuit for producing an indicating signal that, in an active state, indicates that a particular location in the display device is to be represented by the overlay image data; and
an overlay control circuit for fetching the main image data from said memory and being adapted to respond to a transition in said indicating signal to said active state by halting said fetching.

2. The graphics controller of claim 1, wherein said indicating signal, in an inactive state, indicates that a particular location in the display device is to be represented by the main image data, and wherein said overlay control circuit is further adapted to resume said fetching in response to a transition in said indicating signal from said active state to said inactive state.

3. The graphics controller of claim 2, wherein said overlay control circuit is adapted to increment the address used for said fetching by an amount sufficient to skip the main image data corresponding to the locations in the display device for which said indicating signal is in said active state.

4. The graphics controller of claim 3, wherein there is a difference in the resolution of the main image data and the resolution of the overlay image, wherein said overlay control circuit further comprises a scaling circuit for determining the amount said address is incremented by producing a scale factor representing said difference.

5. The graphics controller of claim 1, wherein said memory comprises a first portion for storing the main image data and a second portion for storing the overlay image data, further comprising a main image display pipe for transmitting the main image data from said first portion of said memory to the display device, and an overlay image display pipe for transmitting the overlay image data from said second portion of said memory to said display device, wherein said overlay control circuit is further adapted to write the main image data fetched from said first portion of said memory to the main image display pipe and to write the overlay image data fetched from said second portion of said memory to the overlay image display pipe.

6. The graphics controller of claim 5, wherein said overlay control circuit further comprises a pipe enable controller for enabling and disabling said main display pipe, wherein said pipe enable controller is adapted to respond to said indicating signal being in said active state by disabling said main display pipe.

7. The graphics controller of claim 6, wherein said indicating signal, in an inactive state, indicates that a particular location in the display device is to be represented by the main image data, and wherein said overlay control circuit is further adapted to resume said fetching in response to a transition in said indicating signal from said active state to said inactive state.

8. The graphics controller of claim 7, wherein said controller is adapted to increment the address used for said fetching by an amount sufficient to skip the main image data corresponding to the locations in the display device for which said indicating signal is in said active state.

9. The graphics controller of claim 8, further comprising a scaling circuit for scaling the number of pixels of said main image data to determine the amount said address is incremented.

10. A method for providing main image data and overlay image data to a display device, comprising:
a first step of indicating that a particular location in the display device is to be represented by the overlay image data;
fetching the main image data from a memory; and
responding to said first step of indicating by stopping said fetching.

11. The method of claim 10, further comprising a second step of indicating that a particular location in the display device is to be represented by the main image data, and resuming said fetching in response to switching from said first step of indicating to said second step of indicating.

12. The method of claim 11, further comprising incrementing the address used for said fetching by an amount sufficient to skip the main image data corresponding to the locations in the display device associated with said first step of indicating.

13. The method of claim 12, wherein there is a difference in the resolution of the main image data and the resolution of the overlay image, the method further comprising determining the amount said address is incremented by producing a scale factor representing said difference.

14. The method of claim 10, further comprising transmitting the main image data from the memory to the display device through a main image display pipe, transmitting the overlay image data from the memory to the display device through an overlay imaged display pipe, writing the main image data fetched from the memory to the main image data display pipe, and writing the overlay image data fetched from said second portion of said memory to said overlay image display pipe.

15. The method of claim 14, further comprising responding to said first step of indicating by disabling said main display pipe.

16. The method of claim 15, further comprising a second step of indicating that a particular location in the display device is to be represented by the main image data, and resuming said fetching in response to switching from said first step of indicating to said second step of indicating.

17. The method of claim 16, further comprising incrementing the address used for said fetching by an amount sufficient to skip the main image data corresponding to the locations in the display device for which said signal is active.

18. The method of claim 17, wherein there is a difference in the resolution of the main image data and the resolution of the overlay image, the method further comprising determining the amount said address is incremented by producing a scale factor representing said difference.

19. A medium readable by a machine embodying a program of instructions executable by the machine to perform a method for providing main image data and overlay image data to a display device, the method comprising:
a first step of indicating that a particular location in the display device is to be represented by the overlay image data;
fetching the main image data from a memory; and
responding to said first step of indicating by stopping said fetching.

20. The medium of claim 19, the method further comprising a second step of indicating that a particular location in the display device is to be represented by the main image data, and resuming said fetching in response to switching from said first step of indicating to said second step of indicating.

21. The medium of claim 20, the method further comprising incrementing the address used for said fetching by an amount sufficient to skip the main image data corresponding to the locations in the display device associated with said first step of indicating.

22. The medium of claim 21, wherein there is a difference in the resolution of the main image data and the resolution of the overlay image, the method further comprising determining the amount said address is incremented by producing a scale factor representing said difference.

23. The medium of claim 19, wherein the main image data are transmitted from the memory to the display device through a main image display pipe, wherein the overlay image data are transmitted from the memory to the display device through an overlay imaged display pipe, the method further comprising writing the main image data fetched from the memory to the main image data display pipe, and writing the overlay image data fetched from said second portion of said memory to said overlay image display pipe.

24. The medium of claim 23, the method further comprising responding to said first step of indicating by disabling said main display pipe.

25. The medium of claim 24, the method further comprising a second step of indicating that a particular location in the display device is to be represented by the main image data, and resuming said fetching in response to switching from said first step of indicating to said second step of indicating.

26. The medium of claim 25, the method further comprising incrementing the address used for said fetching by an amount sufficient to skip the main image data corresponding to the locations in the display device for which said signal is active.

27. The medium of claim 26, wherein there is a difference in the resolution of the main image data and the resolution of the overlay image, the method further comprising determining the amount said address is incremented by producing a scale factor representing said difference.

28. A system for displaying main image data and overlay image data, comprising:
a host for providing main and overlay image data;
a graphics display device for receiving the main and overlay image data; and
a graphics controller for controlling the flow of the main and overlay image data from the host to the graphics display device, comprising:
a memory for storing the main image data and the overlay image data;
an indicating circuit for producing an indicating signal that, in an active state, indicates that a particular location in the display device is to be represented by the overlay image data; and
an overlay control circuit for fetching the main image data from said memory and being adapted to respond to a transition in said indicating signal to said active state by halting said fetching.

29. The system of claim 28, wherein said indicating signal, in an inactive state, indicates that a particular location in the display device is to be represented by the main image data, and wherein said overlay control circuit is further adapted to resume said fetching in response to a transition in said indicating signal from said active state to said inactive state.

30. The graphics controller of claim 29, wherein said overlay control circuit is adapted to increment the address used for said fetching by an amount sufficient to skip the main image data corresponding to the locations in the display device for which said indicating signal is in said active state.

31. The graphics controller of claim 30, wherein there is a difference in the resolution of the main image data and the resolution of the overlay image, wherein said overlay control circuit further comprises a scaling circuit for determining the amount said address is incremented by producing a scale factor representing said difference.

32. The graphics controller of claim 28, wherein said memory comprises a first portion for storing the main image data and a second portion for storing the overlay image data, further comprising a main image display pipe for transmitting the main image data from said first portion of said memory to the display device, and an overlay image display pipe for transmitting the overlay image data from said second portion of said memory to said display device, wherein said overlay control circuit is further adapted to write the main image data fetched from said first portion of said memory to the main image display pipe and to write the overlay image data fetched from said second portion of said memory to the overlay image display pipe.

33. The graphics controller of claim 32, wherein said overlay control circuit further comprises a pipe enable controller for enabling and disabling said main display pipe, wherein said pipe enable controller is adapted to respond to said indicating signal being in said active state by disabling said main display pipe.

34. The graphics controller of claim 33, wherein said indicating signal, in an inactive state, indicates that a particular location in the display device is to be represented by the main image data, and wherein said overlay control circuit is further adapted to resume said fetching in response to a transition in said indicating signal from said active state to said inactive state.

35. The graphics controller of claim 34, wherein said controller is adapted to increment the address used for said fetching by an amount sufficient to skip the main image data corresponding to the locations in the display device for which said indicating signal is in said active state.

36. The graphics controller of claim 35, further comprising a scaling circuit for scaling the number of pixels of said main image data to determine the amount said address is incremented.
